(19) United States
(12) Patent Application Publication
(10) Pub. No.: US 2012/0205350 A1
(43) Pub. Date: Aug. 16, 2012

(54) METHOD AND DEVICE FOR WELDING PARTS WITH SPOT CONTACT OR SHORT LINE CONTACT IN THE JOINING REGION AND JOINING DEVICE

(76) Inventor: Uwe Stadtmueller, Kuenzelsau (DE)

(21) Appl. No.: 13/393,357

(22) PCT Filed: Sep. 3, 2010
(86) PCT No.: PCT/DE2010/001041

§ 371 Date: May 1, 2012

(30) Foreign Application Priority Data
Sep. 4, 2009 (DE) 10 2009 040 083.4

(51) Int. Cl. B23K 26/00

(52) U.S. Cl. 219/121.64; 219/121.63

(57) ABSTRACT

Parts are welded by way of a laser beam, wherein the parts are oriented and fixed relative to each other, a laser beam is introduced into an upper part from above and centered relative to a joint point and fuses only the inner region directly above the joint point, while the upper part and the lower part are pressed against each other and therefore move toward one another, wherein the fused region of the upper part penetrates the material of the particular lower part, which has likewise fused in the meantime. Laser welding makes it possible to weld the parts so as to form products having nearly any type of geometry with much less effort than with resistance welding or capacitor discharge welding. The welding device needs only hold and fix the parts to be welded, and apply the slight surface pressure required.

### STATE OF THE ART

The invention is directed to a method and a device for welding parts having spot contact or short line contact in the joining region, which are referred to hereafter as wire-shaped parts, for example, in order to manufacture products having a wire grating structure, such as wire baskets, fencing panels, reinforcing lattices and the like, and in order to weld wire-shaped parts to these intersecting basic structures, the cross section of which is not circular, such as support struts in protective screens for axial fans and the like.

Latticed structures, in which the wire-shaped parts forming the lattice only have spot contact or short line contact at the point of contact or intersection, are manufactured primarily by resistance welding or capacitor discharge welding. A method is known for welding intersecting wires at the crossing point thereof, in which the preformed wires are placed on top of one another and are pressed together specifically at the crossing point. High surge current energy is fed to the particular crossing point by way of electrodes placed thereon, by discharging a capacitor by way of a pulse transformer (capacitor discharge welding). Due to the surface pressure, the thickness of the wires disposed one above the other is reduced when the material fuses, thereby producing an internal flat connection between the wires. The device for carrying out the capacitor discharge welding process comprises a lower electrode on which the part to be welded rests, an upper electrode opposite thereto, and a lifting device for moving the two electrodes toward one another (DE 100 03 428 A1).

The disadvantage of said method relates to the high costs associated with the particular welding devices, which must be produced in a type-specific manner. In particular, the two electrodes must be matched to the particular geometry of the product. The great diversity of types and variants with respect to the number of units, which is often relatively low, therefore results in substantial fixed costs, which often cannot be supported by the products themselves in light of high pricing pressure.

### INVENTION AND THE ADVANTAGES THEREOF

The method according to the invention having the characterizing features of claim 1 has the advantage, by contrast, that the use of laser technology makes it possible to weld the parts, which are wire-shaped at least in the joining region, to form nearly any type of geometry with markedly less expenditure compared to resistance welding or capacitor discharge welding. A suitable device is required for laser welding, as is the case with the aforementioned prior art, of course. It merely needs to hold and fix the parts to be welded, and to apply the slight surface pressure required. Changes need not be made to the laser welding device itself to accommodate different geometries of products.

Laser welding technology has been known for a long time and is used successfully in highly diverse fields of application, even without the use of filler material. However, it has not yet been possible to produce adequate-quality connections between intersecting wire-shaped parts, that is, parts having only spot contact or at the most short line contact at the crossing point and, therefore, at the joint point thereof. It is known that, when welding parts using a laser beam source without filler material, the two parts must lie tightly on top of one another, that is, a significant air gap must not be present between the parts, in order for the laser beam to fuse the materials in the junction region. This is not the case with wire-shaped parts to be welded to one another, however. In this case, only one spot contact point is present, with air to the right and left thereof. Short line contact, for instance when connecting wire rings to a support strut having a rectangular cross section, is likewise inadequate for laser welding.

In order to utilize laser welding, which is advantageous, to nevertheless weld wire-shaped parts, in the method according to the invention, the laser welding device is positioned above the crossing point. The laser beam passes through the upper part to the crossing point and fuses the material in the focal point, which is focused above the joint point but still within the upper part thereof. By passing the laser beam through the upper part, the energy thereof is not diminished by a gap that may be present. Instead, it precisely strikes the crossing point from the inside. To prevent the material from running out of the upper part, which has been “fused open”, the part is fused only in the center region of the cross section thereof, while no fusing takes place at either side, so that the liquid material is enclosed in a type of micro-melt in the cross section, while, in the contact zone, heat is already being introduced into the lower part, the material of which fuses at this point at least in the region adjoining the joint point.

In this phase of the fusing of the material of the upper part and the lower part, it is therefore particularly important for the wire-shaped parts to still be pressed together slightly during the laser welding process, even though this is applied outside of the crossing point, which is to say, the joint point. To this end, the parts are placed under a slight preload by way of sinking forces acting at the sides of the joint point, which move the parts slightly toward one another. As a result, the fused zone and, therefore, the contact surface of the two parts increases substantially. When the materials are paired accordingly, a pronounced welding bead forms, which is the sign of a high-quality welded joint point. The sinking forces to be applied in this case are markedly lower than the pressure forces required for capacitor discharge welding because the only objective in this case is to establish contact between the two parts and to “sink” the upper part into the fused material of the lower part. The sinking forces must be maintained until the material in the joint point hardens.

According to an additional advantageous embodiment of the invention, the laser beam is aimed orthogonally at the parts to be joined. This ensures that precisely that region of the upper part located centrally above the contact point is fused.

According to an additional advantageous embodiment of the invention, the sinking forces to be applied to the parts to be welded together is applied by a spring force. In the compressed state, they provide the required preloading of the parts, and therefore the parts move toward one another due to the formation of the fusion zone, with the spring force being maintained until the fused material hardens.

According to another advantageous embodiment of the invention, after the molten metal at the joint point has hardened, the fillet regions of the joint point are also welded, on one side or several sides. To produce such a side weld, the laser beam is used, starting at the interior of the wire, to fuse a portion of the cross section of the upper wire-shaped part, which is still intact, but without moving the parts closer together. To produce a plurality of side welds, this process is repeated after the laser beam is displaced radially. Side welds enlarge the connection cross section of the parts in the fusion zone and therefore increase the strength of the welded joint point.

According to another advantageous embodiment of the invention, the laser beam is controlled by a scanner that registers the coordinates of the joint points. As a result, the production time for products comprising several joint points, such as wire grating, is substantially reduced.

According to a particularly advantageous embodiment of the invention, the parts to be interconnected are first positioned merely approximately relative to one another. The fine positioning carried out in conjunction with fixation then takes place immediately before the laser welding process, while the parts are being pressed together. This has the advantage that the manual placement of the parts into the device, which is in itself complicated, is substantially simplified and, therefore, accelerated.

The device according to the invention for producing the welded joint point, which has the features of claim 7, has the advantage that the parts are held, positioned, fixed and pressed together in a separate device that is used independently of the actual welding apparatus. During compression, force is introduced into the upper part laterally with respect to the joint point and, therefore, outside of the entry point of the laser. As a result, it is only necessary to match the separate device to the shape of the final product, thereby markedly reducing the costs of the entire device compared to capacitor discharge welding devices.

According to an advantageous embodiment of the device, the laser is combined with a scanner, which very quickly determines the positions of the joint points, with which the laser beam is then aligned, thereby substantially shortening the welding time required to connect all joint points of the finished product.

According to an embodiment of the invention that is advantageous in this regard, the scanner is mounted on a robot. For products that are larger than the scanner field, the scanner is displaced by the robot, which can likewise be carried out rapidly and with great accuracy in a computer-aided manner.

According to an additional advantageous embodiment of the invention, the means for pressing the parts together comprise resilient, springy elements that act outside of the joint points on the upper part or parts, thereby applying a preload onto the parts and moving the two parts toward one another.

Instead of the springy elements, it is also possible, however, to use an elastic material that is applied on a carrier extending across all of the joint points or only some of the joint points. This embodiment is simpler and, therefore, less expensive than the use of springy elements. In addition, exact positioning, which is still required by the compression springs, is eliminated because an elastic band always touches the wire-shaped parts to be pressed together. The elastic material can also be used to compensate for tolerances in a simple manner. Moreover, the elastic material has the advantage that it protects the upper parts against damage.

According to another advantageous embodiment of the invention, the means for pressing the parts together are fastened to a hold-down device, which is moved toward the upper wire-shaped parts to the extent that the compression means rests against the upper parts with the required preload. It is advantageous for the hold-down device to be designed, at least in subregions, in the shape of the surface of the product to be produced. In this region, the means for holding down the upper wire-shaped parts can then have the same length, which is advantageous particularly when an elastic band is used to apply the preload,

According to a particularly advantageous embodiment of the invention, the means for pressing the parts together are disposed on a device for the fine positioning and fixation of said parts in the welding position. The parts are placed merely approximately in a base device. Said device performs the fine positioning and fixation and has an appropriate shape therefor.

According to an embodiment of the invention that is advantageous in this regard, such a shape is a comb strip, the tines of which are beveled at the free end. The tooth spaces lying therebetween narrow to the thickness of the parts to be positioned, wherein the narrow distance then also corresponds to the desired position of the part sliding into the tooth space when the comb strip is pressed downward. Advantageously, the tooth gullet of the tooth space is provided with an elastic material for applying the sinking force.

According to another advantageous embodiment of the device, the means for pressing the upper parts and the lower parts together are designed to apply the sinking force only at a single joint point. Although such a device is relatively simple, the laser beam must always be moved from joint point to joint point and positioned.

It is more advantageous to allow the hold-down device to act on a plurality of joint points simultaneously, although, as mentioned above, this must be matched to the shape of the area in which the joint points are located. The production times for the products can be shortened as a result.

It is particularly advantageous to design the hold-down device as a complete tool that can be used to act upon all joint points of a product simultaneously using the required sinking force. In this embodiment of the invention, the hold-down device therefore has the shape of the surface of the product. It is also particularly advantageous to allow the hold-down device to also perform the function of fine-positioning the upper parts.

Further advantages and advantageous embodiments of the invention will become apparent from the description of an example presented in the following, and from the drawings and the claims.

### DRAWINGS

An exemplary embodiment of the invention is depicted in the drawings with reference to the production of a protective screen for axial fans, and is described in greater detail in the following. Shown are:

FIG. 1: a protective screen manufactured according to the invention,

FIG. 2: the placement of a hold-down device on wire rings disposed in the closed position with respect to a support strut,

FIG. 3: the principle of the introduction of the sinking force into the wire rings,

FIG. 4: the phases of the laser welding process,

FIG. 5: a device for applying the pressure force,

FIG. 6: a development of the device,

FIG. 7: a joining device for producing a protective screen for axial fans by laser welding, in the opened state, and

FIG. 8: said joining device in the closed state.

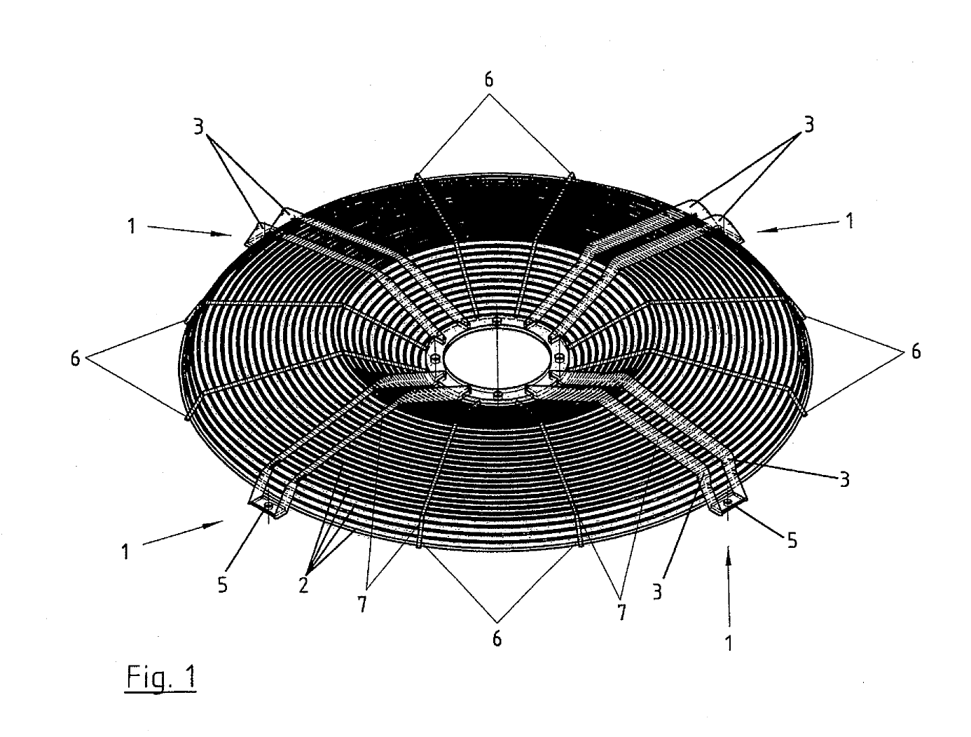

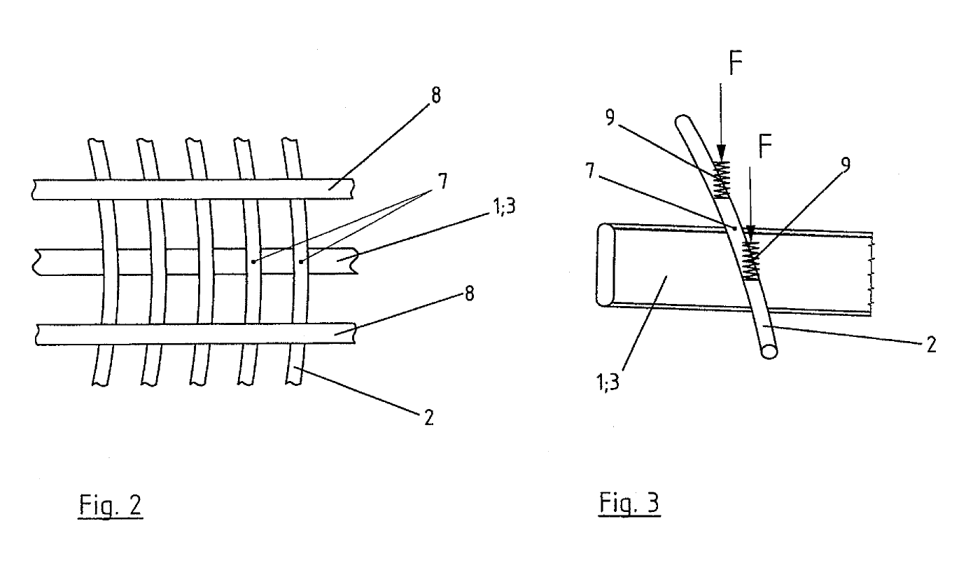

FIG. 1: shows a three-dimensional protective screen comprising four support struts 1 onto which concentric screen rings 2 are welded. Each support strut 1 comprises two flat profiles 3, which extend in parallel and are angled at different angles twice over the high edge, the inner ends of which are connected to an inner flange ring 4 and the outer ends of which are interconnected to form an outer flange ring 5. Two round struts 6 are disposed with uniform spacing between the support struts 1 in each case. The screen rings 2 are welded to one another by laser welding at the crossing points with the flat profiles 3 and the round struts 6 (FIG. 2). For simplicity, the short line contact between the screen ring 2 and the flat profile 3 is also considered to be a crossing point. Both crossing points are referred to in the following as a joint point (7).

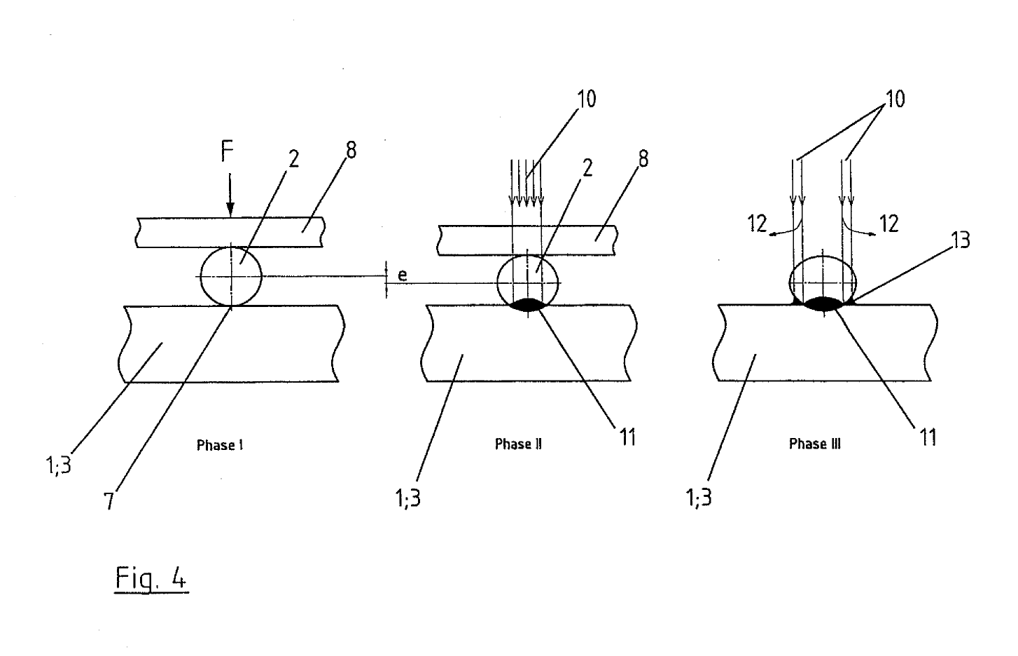

FIG. 2 and FIG. 3 show the principle of applying the sinking force that accompanies the laser welding process. To this end, FIG. 2 schematically shows a section of the protective screen depicted in FIG. 1, wherein, for simplicity, the support strut 1 is depicted here as comprising only one flat profile 3, whereas the reference numeral 3 provided after a semicolon following reference numeral 1 in the drawing indicates that this support strut 1 is also the flat profile 3. The screen rings 2 are positioned on the support strut 1 equidistantly with respect to one another, and cross the support strut 1 at an angle of 90°. A hold-down device 8 lies on the screen rings 2 on both sides of the joint points 7. The pressure force F applied by the hold-down device 8 onto the screen rings 2 is illustrated in FIG. 3 by way of the two spring elements 9.

FIG. 4 shows the scheme for the phases of the laser welding process, using the example of a single welding point, in which the flat profile 3 of the support strut 1 is cut lengthwise and the screen ring 2 is depicted cut transversely to the longitudinal axis thereof. In addition, the central point of the screen ring 2 is indicated using dash-dotted lines. In phase I, in a device that is not shown, the support strut 1 and the screen ring 2 are brought into position relative to one another and are pressed against one another by way of the pressure force F, which is applied onto the screen ring 2 by the hold-down device 8 located behind and in front of the joint point 7 with respect to the image plane. In phase II, a laser beam 10 is introduced perpendicularly from above and centrally into the screen ring 2 and is focused so as to fuse the lower central region of the cross section of the screen ring 2. Fusion does not take place at the two sides, and therefore the liquid material is enclosed in a micro-melt in this region of the screen ring 2 and thus cannot run out. The thermal energy contained in the micro-melt is transmitted naturally by way of thermal conduction to the surface region of the support strut 1 disposed directly underneath, which then also fuses. Due to the effect of the pressure force F, the screen ring 2 penetrates the fused surface region of the support strut 1, which is fixed in the device and therefore cannot escape, and covers a sinking distance e. The contact surface between the support strut 1 and the screen ring 2 increases noticeably, and a welding bead 11 forms in this region. The pressure force F is maintained until the molten metal hardens.

The strength of the welding point can be increased further by creating fillet welds in the edge regions of the screen ring 2, as shown in phase Ill in FIG. 4. To this end, after the welding bead 11 has hardened, the laser beam 10 is guided out of the interior of the screen ring 2 and into the edge regions thereof. The welding direction selected for this purpose was labeled “12”. Since the screen ring 2 is fixed with respect to the support strut 1 by the welding bead 11, the molten metal forming from the edge region will flow into the cavity of the fillet located below and form a side weld 13 there. This process can take place on both sides of the cross section of the screen ring 2.

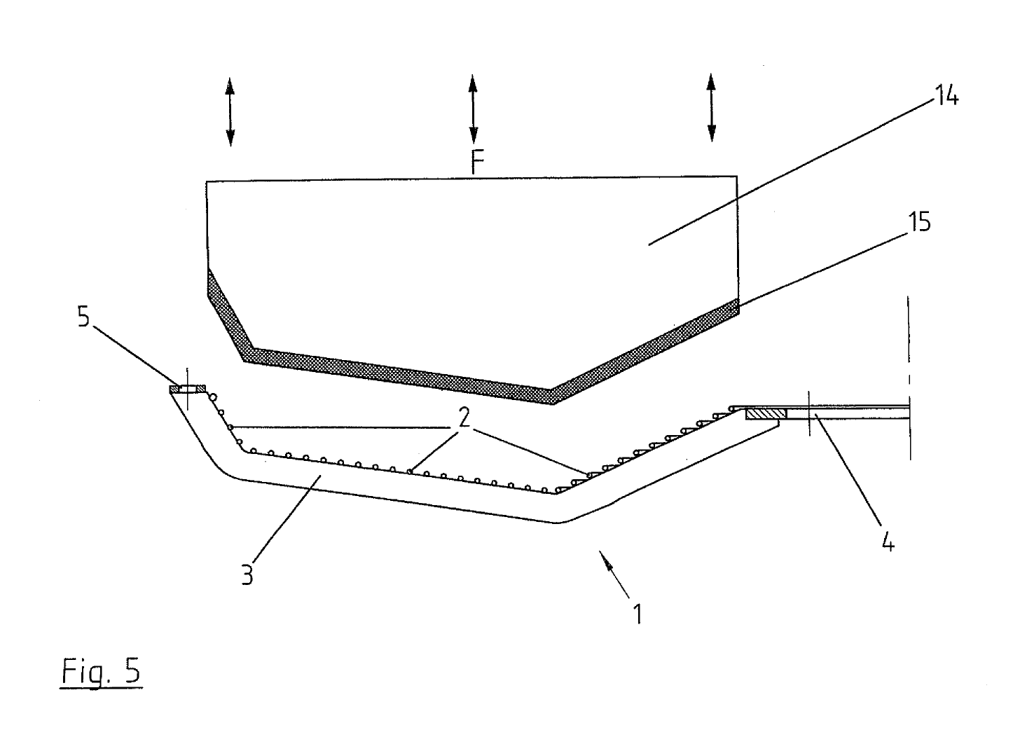

FIG. 5 shows a schematic depiction of a device for applying the pressure force F using the example of the production of a protective screen for axial fans, as depicted in FIG. 1. The support struts 1 are disposed with the top side thereof facing downward. The screen rings 2 are fixed in the welding position on the underside of the support strut 1. A hold-down device 14 is disposed above the screen rings 2, the underside of which is matched to the contour of the support struts 1 in the region of the screen rings 2, and is provided with an elastomer band 15. When the hold-down device 14 is lowered, the elastomer band 15 in the joining region presses onto the screen rings 2 and transfers pressure force F thereto. Due to the resilience thereof, it quickly adapts to the screen rings 2 and thereby compensates for any tolerances. Due to the shape of the hold-down device 14, all the screen rings 2 lying on a support strut 1 can be pressed onto the support strut 1 with the pressure force F, using a single stroke of the hold-down device 14 on this support strut 1. When resilient, springy elements are used, as represented by the elastomer band 15, the pressure force F must be selected so as to be great enough that, after the screen rings 2 sink into the support strut 1, adequate residual tension is maintained until the molten metal hardens.

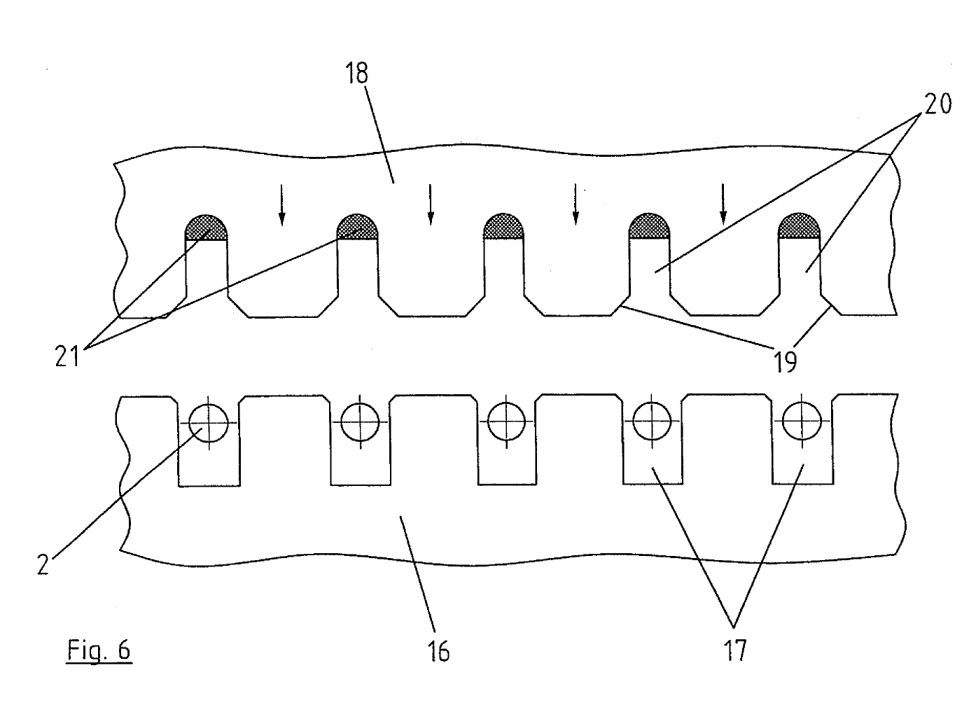

FIG. 6 shows a development of the device from FIG. 5 in which the means by which the pressure force F is applied to the parts to be interconnected also carries out the exact positioning and fixation thereof. FIG. 6 shows only the parts of the device that are relevant therefor, namely a lower part 16, which accommodates the screen rings 2 in insertion grooves 17. The vertical position of the screen rings 2, which corresponds to the mating surface of the support struts, which are not shown here, is determined by the depth of the insertion grooves 17, the width of which is designed to be markedly greater than the diameter of the screen rings 2, thereby enabling the screen rings 2 to be easily placed into the lower part 16. These fall directly onto the bottom of the insertion grooves 17 and are therefore prepositioned in an approximate manner in terms of the radial positioning thereof. Moreover, the device comprises a hold-down device 18 in which, proceeding from the underside thereof, fixing grooves 20 are incorporated, each of which is equipped with a centering phase 19. The end of the fixing grooves 20 is semicircular and is provided with an elastomer insert 21.

As shown in FIG. 5 as well, the width of the fixing grooves 20 in the hold-down device 18 is smaller than that of the insertion grooves 17 of the lower part 16. Including a slight positive tolerance, it corresponds to the diameter of the screen rings 2. The hold-down device 18 is offset with respect to the lower part 16 in the direction of the axis of the screen rings 2 by the width of the joint point. When the hold-down device 18 is lowered, the screen rings 2, which lie loosely in the insertion grooves 17 of the lower part 16, are positioned by the centering phases 19 in the center with respect to the narrower fixing grooves 20, thereby enabling them to assume their final radial position. As the downward motion of the hold-down device 18 continues, the elastomer insert 21 comes to rest on the screen rings 2 and is compressed until the preload required to press the screen rings 2 and the support struts 1 against one another has been reached. Now, as described above, the screen rings 2 are connected to the support struts 1 by laser welding, while the preload is maintained by the hold-down device 18, with the result that the screen rings 2 are sunk in the direction of the support struts 1, and the preload is maintained until the molten metal in the joint point hardens. It may be necessary for the lower part 16 to simultaneously cover the slight sinking distance e of the screen rings 2. It is also possible, once the screen rings 2 have been placed into the lower part 16, to move the support struts, which are likewise positioned in a recess, against the screen rings 2 from below, and thereby slightly lift them off of the bottom of the insertion grooves 17, which is then no longer in the way when the screen rings 2 are sunk.

The invention is described hereafter by reference to an additional example, according to which the protective screen for an axial fan is produced in entirety by laser welding, which is to say, including all struts and an inner flange ring 4 and an outer flange ring 5, in a single joining device that operates using a method according to the invention.

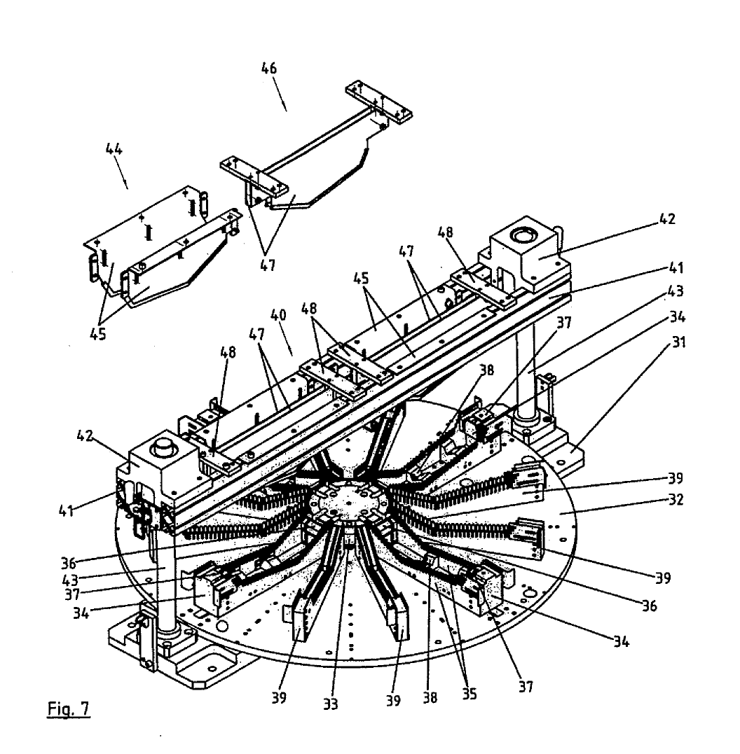

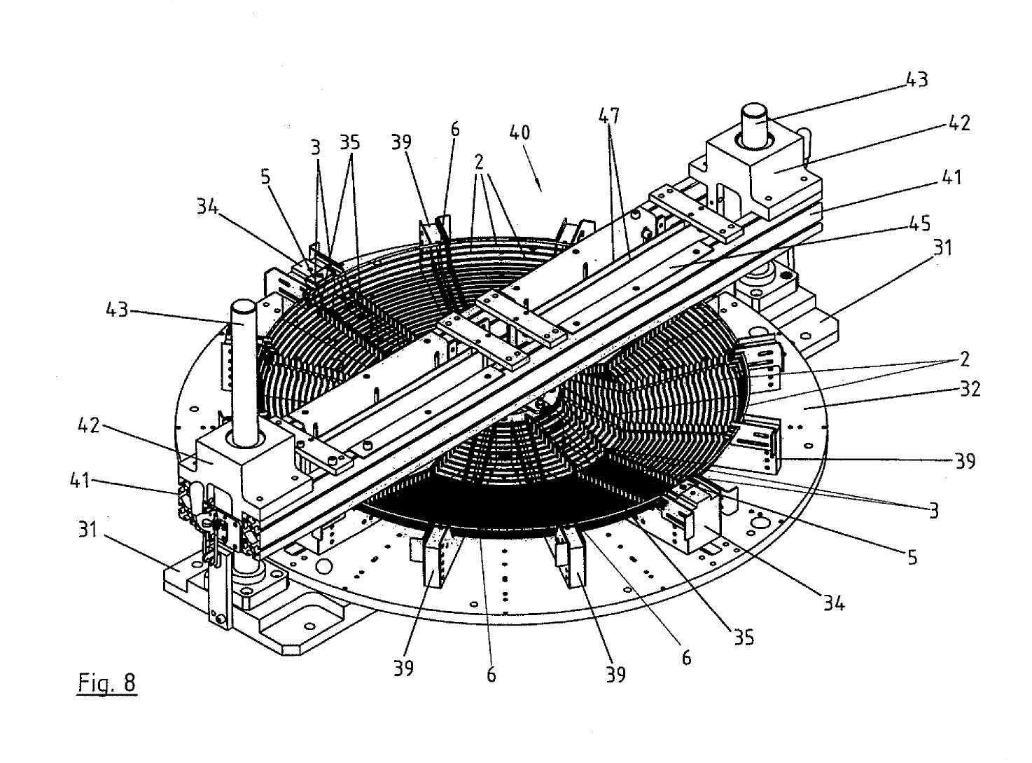

FIGS. 7 and 8 are the identical depiction of the joining device, in the opened position (FIG. 7) and in the closed position (FIG. 8), wherein, in the closed position, all the parts to be welded together have been inserted. As shown in FIGS. 7 and 8, the joining device comprises a console 31, which rotatably accommodates a base plate 32. An inner flange seat 33 is disposed in the rotation point of the base plate 32. Four receiving devices 34 for the support struts 1 extend outward therefrom with a spacing of 90°, being diametrically opposed in sets of two. Each receiving device 34 comprises a right and a left comb strip 35, which receive and approximately position the screen rings 2 as shown and described in FIG. 6. Before the screen rings 2 are inserted, however, two flat profiles 3 are placed into the receiving device 34, the flat profiles being bent over the high edge in accordance with the shape of the support strut 1 and being designed at the inner and outer ends thereof for connection to the inner flange ring and the outer flange ring 4, 5, respectively. To this end, the receiving device 34 comprises an inner seat 36, which faces the inner flange seat 33, an outer seat 37 disposed on the outer end, and holding elements 38. The outer seats 37 simultaneously serve to accommodate tabs, by way of which the outer ends of the flat profiles 3 are welded to the outer flange ring 5.

Insertion devices 39 for the round struts 6 (see also FIG. 1) are disposed with uniform spacing between the receiving devices 34 for the support struts 1. The insertion devices 39 are designed similarly to the receiving devices 34, with the exception that they accommodate only one round strut 6, which is already curved in the shape matched to the protective screen, in the same manner as the flat profiles 3. They are likewise equipped with comb strips 35 on both sides for the approximate radial prepositioning of the screen rings 2.

A yoke 40, which bridges the entire diameter of the base plate 32, is disposed above the base plate 32, centrosymmetrically with respect to the rotational axis thereof. It comprises two parallel profiled elements 41 connected to each other at the outer ends thereof by way of a guide element 42. Each guide element 42 is supported in a gliding manner on a guide shaft 43 mounted in the console 31 equidistantly from the rotational axis, thereby allowing the yoke 40 to move vertically in the direction of the rotational axis of the base plate 32 and thereby simultaneously bridge two opposing receiving devices 34 or insertion devices 39 at a time.

All of the hold-down devices required to apply the sinking forces during welding of the screen rings 2 to the flat profiles 3 and the round struts 6 are disposed in a height-adjustable manner in the intermediate space between the two profiled elements 41 on both sides of the rotational axis of the base plate 32. To illustrate the design of the hold-down devices, they are also shown in the disassembled state in FIG. 7 as a separate detail. One is an outer hold-down device 44 comprising two parallel hold-down device plates 45 separated by a wide distance and angled at the upper edge thereof, and one is an inner hold-down device 46 comprising two parallel, flat hold-down device plates 47 separated by a narrow distance and connected to one another at the ends thereof by way of a holder 48. While the angled hold-down device plates 45 each lie by way of the angled shape thereof on a profiled element 41 and are fastened thereto, the inner hold-down device 46 is symmetrically inserted into the intermediate space between the angled hold-down device plates 45 of the outer hold-down device 44, and therefore the flat hold-down device plates 47 are fixed on the two profiled elements 41 with the holder 48 thereof. The lower edge of the hold-down device plates 45 and 47 is matched to the shape of the support strut 1 or the round strut 6. The separation of the hold-down device plates 45 and 47 with respect to one another is determined by the separation of the flat profiles 3 of the support strut 1. The distance between the angled hold-down support plates 45 is greater than the width of the support strut 1, thereby permitting them to come to rest on the screen rings 2 outside of the support strut 1 when the yoke 40 is lowered, while the distance between the flat hold-down device plates 47 is smaller than the distance between the flat profiles 3, thereby enabling them to come to rest within the support strut 1, which is to say, between the two flat profiles 3 thereof.

The sinking force applied to press the screen rings 2 onto the support struts 1 and the round struts 2 during the welding process is transmitted by the yoke 40 to the screen rings 2 by way of the hold-down devices 44 and 46. All the hold-down device plates 45, 47 press onto the screen rings 2 with the same force, thereby ensuring that the screen rings 2 will not tilt.

The fine positioning of the screen rings 2 using the hold-down device plates 45, 47, as shown and described in FIG. 6, is not depicted in FIGS. 7 and 8 to ensure clarity. It is a component of the present joining device, however, as the comb strips 35 of the receiving device 34 and the insertion device 39 merely approximately position the screen rings 2.

The joining device described is therefore a universal welding device for producing protective screens for axial fans. After all the parts to be interconnected have been placed in the corresponding receiving and insertion devices 34, 39 and the associated hold-down devices 44, 46 have been fastened in the yoke 40, the base plate 32 is rotated so that the yoke 40 is located directly over two diametrically opposed receiving or insertion devices 34, 39. The yoke 40 then moves downward until the hold-down device plates 45, 47 rest on the screen rings 2 and apply the necessary preload thereto. A laser welding device, which is positioned above the yoke 40 but is not depicted in FIGS. 7 and 8, successively acts on each of the crossing points of the screen rings 2, which are located underneath the yoke 40 and comprise the flat profiles 3 or the round struts 6, the crossing points being referred to hereinafter as joint points. To connect the screen rings 2 to the round struts 6, the laser beam must be guided exactly through the center of the intermediate space formed by the two flat hold-down device plates 47 to the particular joint point, while, to connect the screen rings 2 to one of the two flat profiles 3, it must be guided through the intermediate space formed by an outer angled hold-down device plate 45 and the inner flat hold-down device plate 47 adjacent thereto.

The laser beam welds the lower region of the screen ring 2, as shown and described in FIG. 4. Due to the preload applied by the outer hold-down device and the inner hold-down device 44, 46, respectively, the screen ring 2 is sunk in this region, the screen rings 2 being prevented from tilting due to the placement of the hold-down device plates 45, 47 symmetrically with respect to the joint point. After the joint point has hardened, the yoke 40 moves back upward to the extent that the screen rings 2 are free. The base plate 32 is rotated to move the next two diametrically opposed receiving or insertion devices 34, 39 underneath the yoke 40. The yoke 40 moves downward once more, applies the necessary preload onto the screen rings 2, and the laser beam once more acts on the joint points located underneath the yoke 40. These processes are repeated until all the joint points have been welded.

In the present example, the base plate is rotated by a spacing of 30°. Since the support struts 1 comprise two flat profiles 3, the laser beam acts on the line of the joint points twice, offset in parallel, before the base plate 32 is rotated into the next welding position, in order to connect a row of support struts 1 to the screen rings 2. After one row of support struts 1 has been welded, two rows of round struts 2 are welded before the next row of support struts 1 is welded, which is to say, after five spacings of the base plate 32 have been passed through, all the screen rings 2 have been connected to the support struts 1 and the round struts 6. A different welding processes order can, of course, be selected, such as first connecting all the flat profiles 3 to the screen rings 2.

An additional particular advantage of the joining device is that it can be designed as a modular system for producing protective screens of different sizes and shapes. To this end, any type of spacing is incorporated into the base plate in order to produce protective screens having a different number and spacing of support struts 1 and round struts 6. The diameter of the protective screens can be varied by utilizing receiving and insertion devices 34, 39 having different lengths. Finally, the variable design of the inner seat and the outer seat 36, 37, respectively, and the holding elements 38 for the support struts 1 and round struts 6 makes it possible to integrate into the joining device highly diverse parts that determine the shape of the protective screen. Thus, the design of the hold-down devices 44 and 46 can, of course, also be varied, while these can always be easily inserted into the yoke 40, which is unchanged.

The description of the joining device presented above only describes the welding of those parts of the protective screen that have spot contact or short line contact in the joining region, namely the screen rings 2 comprising the support struts 1 and the round struts 6. At the beginning of the descriptions of FIGS. 7 and 8, however, it was stated that the protective screen can be welded in entirety using this joining device. Therefore, the welded connections for which the method according to the invention cannot be used will be outlined briefly in the following, because the parts to be connected to one another have a joining surface that is large enough for laser welding, and a disruptive air gap is not present:

This applies for the connection of the inner ends and the outer ends of the flat profiles 3 to the inner flange ring 4 and the outer flange ring 5, respectively. These can be welded without changing the position of the laser welding device above the yoke 40 because they are always located in or near the radial axis of the support struts 1 and, therefore, always underneath the intermediate space formed by the profiled elements 41 of the yoke 40 when the support struts 1 are being positioned in the welding position. When the base plate 32 is being adjusted to a welding position for the support strut 1, these connections are accessible to the laser beam when the outer hold-down device and the inner hold-down device 44, 46, respectively, have been removed from the yoke. In order to weld the outer flange ring 5, it is also possible, however, to move the laser welding device to a position outside the yoke 40. This variant is possible for welding the inner flange ring 4, only if the joint point thereof is located outside the yoke 40, which is to say, when the diameter thereof is greater than the width of the yoke 40.

All the features presented in the description, the following claims and the drawings can be essential to the invention individually and in any combination.

### LIST OF REFERENCE CHARACTERS

1 support strut
2 screen ring
3 flat profile
4 inner flange ring
5 outer flange ring
6 round strut
7 joint point
8 hold-down device
F pressure force
9 spring element
10 laser beam
e sinking distance
11 welding bead
12 welding direction
13 side weld
14 hold-down device
15 elastomer band
16 lower part
17 Insertion groove
18 hold-down device
19 centering phase
20 fixing groove
21 elastomer insert
31 console
32 base plate
33 inner flange seat
34 receiving device
35 right and left comb strip
36 inner seat
37 outer seat
38 holding element
39 insertion device
40 yoke
41 profiled element
42 guide body
43 guide shaft
44 outer hold-down device
45 angled hold-down device plate
46 inner hold-down device
47 flat hold-down device plate
48 holder

1. A method for welding parts having spot contact or short line contact in the joining region, comprising using a laser beam Oft wherein the parts are oriented and fixed with respect to one another, wherein the laser beam is introduced into an upper part from above and centered relative to a joint point in such a way that only an inner region directly above the joint point fuses, while the upper part or parts and a lower part or parts are pressed against each other and therefore move toward one another during the welding process, wherein the fused region of the particular upper part penetrates the material of the particular lower part, which has likewise fused in the meantime due to the heat introduced by this molten metal.

2. The method according to claim 1, wherein the laser beam orthogonally strikes the parts to be fused.

3. The method according to claim 1, wherein the upper part or parts and the lower part or parts are pressed together by a spring force.

4. The method according to claim 1, wherein after the molten metal in the joint point has hardened, the fillet regions of the joint point are also welded, on one side or several sides, from the interior of the upper part outward.

5. The method according to claim 1, wherein the laser welding is carried out in combination with a scanner, which registers the coordinates of the joint points and controls the laser beam.

6. The method according to claim 1, wherein the parts to be connected to one another are initially positioned only approximately with respect to one another and the fine positioning is carried out while the parts are being pressed together.

7. A device for welding parts having spot contact or short line contact in the joining region, comprising a receiving device for positioning and fixing the parts in a welding position; a laser welding device, wherein the laser beam is positioned above an upper part and centered with respect to a joint point, and means for pressing the upper part or parts and the lower part or parts together, wherein these means are disposed laterally with respect to the joint point.

8. The device according to claim 7, wherein the laser is combined with a scanner.

9. The device according to claim 8, wherein the scanner is mounted on a robot.

10. The device according to claim 7, wherein the means for pressing the parts together comprise resilient, springy elements that act outside of the joint points on the upper part or parts.

11. The device according to claim 10, wherein the resilient, springy elements are made of a resilient material.

12. The device according to claim 7, wherein the means for pressing the parts together are fastened to a hold-down device.

13. The device according to claim 7, wherein the means for pressing the parts together are combined with a device for the fine positioning of these parts in the welding position.

14. The device according to claim 13, wherein the device for the fine positioning of the upper parts comprises a comb strip.

15. The device according to claim 7, wherein the means for pressing the upper and lower parts together act on only one joint point at a time.

16. The device according to claim 7, wherein the means for pressing the upper and lower parts together act on a plurality of joint points simultaneously.

17. The device according to claim 16, wherein the means for pressing the upper and lower parts together are in the form of a complete tool, which acts simultaneously on all the joint points of the parts to be welded to one another.

18. A joining device for producing products having a latticed structure, for example protective screens for axial fans, wherein the latticed structure comprises parts that cross one another and have spot contact or short line contact in the crossing region, and the parts are welded to one another in the crossing region, which is referred to hereafter as the joint point, the joining device comprises the following:
a laser welding device, wherein the laser beam is positioned above the upper part and centered with respect to a joint point, a rotatably mounted base plate, on which receiving devices for the positioning and fixation of the lower parts and the upper parts in the welding position are disposed, a receiving device for hold-down devices, which is disposed centrosymmetrically with respect to the rotational axis of the base plate and is vertically displaceable, wherein the hold-down devices, are disposed opposite one another in pairs in the receiving device and therefore border an intermediate space extending radially with respect to the base plate, the intermediate space aligning with the radially extending joint points of the parts to be welded together during the positioning of a receiving device underneath the vertically displaceable receiving device, wherein the lower edge of the hold-down devices is formed in accordance with the shape of the lower parts extending perpendicularly to the plane of rotation of the base plate and comes to rest on the upper parts next to the joint point in each case when the receiving device is lowered, and means for applying a pressure force by way of the hold-down devices onto the parts to be welded to one another during the welding process until the joint point that has been welded most recently and is disposed underneath the receiving device has hardened.
